(19) United States
(12) Patent Application Publication
(10) Pub. No.: US 2008/0062992 A1
(43) Pub. Date: Mar. 13, 2008

(54) Message Transfer System and Message Transfer Method

(75) Inventors: Hisanori Sawada, Miyagi (JP); Ayumi Eguchi, Fukuoka (JP); Kayo Kobayashi, Saitama (JP); Hidenori Miyamoto, Saitama (JP); Tooru Nasu, Tokyo (JP); Hiroki Yamaguchi, Fukuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NTT DoCoMo, Inc., Chiyoda-ku (JP)

(21) Appl. No.: 11/631,861

(22) PCT Filed: Jun. 30, 2005
(86) PCT No.: PCT/JP05/12086

§ 371 Date: Sep. 26, 2007

(30) Foreign Application Priority Data
Jul. 6, 2004 (JP) 2004-199768

(51) Int. Cl. H04L 12/56

(52) U.S. Cl. 370/392

(57) ABSTRACT

A message transfer system including a transmission request receiver for receiving transmission request information containing a membership number being destination information, and message data, from a Web server or from a communication terminal; a message converter for converting the message data into transmitting message data in a predetermined format; a message output part for adding communication address information corresponding to the membership number to the transmitting message data, and outputting the resultant; and a restricted data detector for, when detecting predetermined restricted object data in the message data in the transmission request information, performing a control not to transmit the restricted object data.

### TECHNICAL FIELD

The present invention relates to a message transfer system and message transfer method for relaying a message on a communication network.

### BACKGROUND ART

A method of transmitting message data via a server such as a mail server connected to a communication network is commonly used as a method of electronically transmitting a message through a communication network. An example of this technology is an e-mail processing system described in Japanese Patent Application Laid-Open No. 2003-233566. This e-mail processing system is configured to receive message data as an object to be transmitted, through a Web browser on a terminal, to add a fixed phrase to the message data to create new message data, and to transmit the new message data to a destination terminal.

### DISCLOSURE OF THE INVENTION

In the conventional e-mail transmitting method as described above, unspecified terminals can transmit various messages, and there are thus cases where a malicious user transmits a harmful message to a destination user or transmits a message with link information for unilateral advertising purposes or the like.

Particularly, the message data is recently often transmitted, for example, by using HTML (HyperText Markup Language) which is a language for describing Web pages. In this case, there are such activities that tag information is added to message data to force a recipient to refer to a specific image file or a sound file, and that link information is added to the message data to guide a recipient so as to refer to a specific Web page. Transmission of such message data annoys the recipient and results in wasting the communication resources on the communication network side.

The present invention has been accomplished in view of the above problem and an object of the present invention is therefore to provide a message transfer system and message transfer method capable of preventing transmission of a useless message by restricting a content of a transmitted message on a communication network.

In order to solve the above problem, a message transfer system according to the present invention comprises transmission request receiving means for receiving transmission request information containing destination information specifying a message destination, and message data to be transmitted to the message destination, from a message sender equipment; message converting means for converting the message data into transmitting message data in a predetermined format; message outputting means for adding communication address information corresponding to the destination information, to the transmitting message data resulting from the conversion by the message converting means, and outputting the resultant; and restricted data detecting means for, when detecting predetermined restricted object data in the message data in the transmission request information received by the transmission request receiving means, performing a control not to transmit the restricted object data.

Alternatively, a message transfer method of the present invention comprises a transmission request receiving step wherein transmission request receiving means receives transmission request information containing destination information specifying a message destination, and message data to be transmitted to the message destination, from a message sender equipment; a message converting step wherein message converting means converts the message data into transmitting message data in a predetermined format; a message outputting step wherein message outputting means adds communication address information corresponding to the destination information, to the transmitting message data resulting from the conversion in the message converting step, and outputs the resultant; and a restricted data detecting step wherein restricted data detecting means, when detecting predetermined restricted object data in the message data in the transmission request information received in the transmission request receiving step, performs a control not to transmit the restricted object data.

In these message transfer system and message transfer method, when a transmission request is received from a message sender, the message data in the transmission request is converted into the predetermined format, the communication address information corresponding to the destination information is added thereto, and the resultant is outputted as transmitting message data. When restricted object data is detected in the message data, the control is performed so as not to transmit the restricted object data to the message destination. Thus, only the message data in the specific format is permitted to be transmitted on the message transfer, and transmission of useless messages is prevented by, for example, restricting transmission of data that are likely to be abused.

### BRIEF DESCRIPTION OF THE DRAWINGS

FIG. 1 is a schematic configuration diagram showing a preferred embodiment of the message transfer system according to the present invention.

FIG. 2 is a diagram showing a configuration of data stored in an authentication information storage shown in FIG. 1.

FIG. 3 is a diagram showing a configuration of data stored in a subscriber information storage shown in FIG. 1.

FIG. 4 is a flowchart showing operation during message transfer of the message transfer system shown in FIG. 1.

FIG. 5 (a) is a diagram showing a content of a template for a conversion process executed by a message converter shown in FIG. 1, and FIG. 5 (b) a diagram showing a content of transmitting message data converted by the message converter shown in FIG. 1.

FIG. 6 is a diagram showing an example of outputting transmitting message data at a communication terminal of a message destination.

FIG. 7 is a diagram showing a modification example of transmitting message data converted by the message converter shown in FIG. 1.

### BEST MODES FOR CARRYING OUT THE INVENTION

An embodiment of the present invention will be described with reference to the drawings. In the drawings the same elements will be denoted by the same reference symbols, without redundant description.

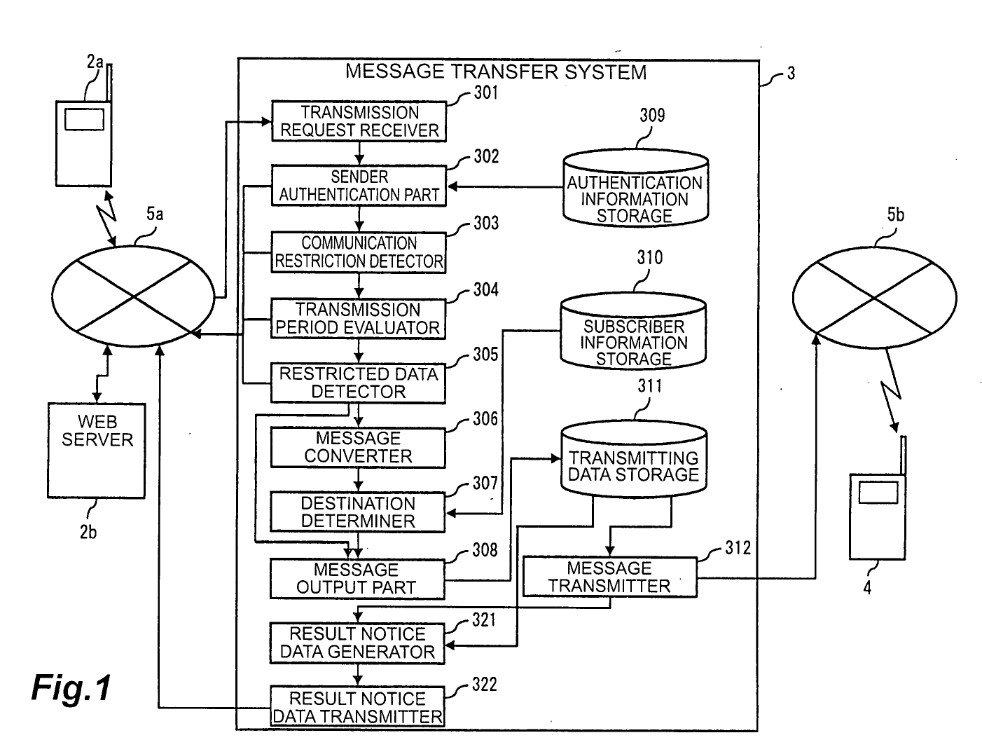

FIG. 1 is a schematic configuration diagram showing a preferred embodiment of the message transfer system according to the present invention. The message transfer system 3 shown in the same drawing is a server unit (or an assembly of server units) for editing and relaying electronic message data. The message transfer system 3 is connected to Web server 2b and communication terminal 2a through communication network 5a so as to be able to communicate with them and is also connected to communication terminal 4 through communication network 5b so as to be able to communicate with it. Each of the communication networks 5a, 5b is a communication network such as a mobile telecommunications network, a fixed-line network, a private line, an Internet network, and a combination of these communication networks. In FIG. 1, for convenience' sake of description, there are the communication terminals 2a, 4 and Web server 2b one each illustrated, but the system may incorporate other communication terminals and Web servers not illustrated.

The Web server 2b is a server unit that delivers data for displaying of Web pages providing various information such as commodity information, premium point information, and account balance information to users using communication terminals. The Web server 2b also functions as a server unit (message sender equipment) used by a message sender that intends to transmit message data to communication terminal 4.

The communication terminal 2a is a communication terminal (message sender equipment) used by a message sender, and the communication terminal 4 is a communication terminal as a message destination designated by the message sender. The communication terminals 2a, 4 can be selected from a variety of communication terminals such as cell phones, PHSs (Personal Handyphone Systems), PDAs (Personal Digital Assistants), and personal computers, and are preferably mobile telecommunications terminals such as the cell phones, PHSs, and PDAs in terms of high convenience in connection from users to communication networks 5a, 5b.

The message transfer system 3 has a function of transferring message data from Web server 2b or from the communication terminal 2a for message sender equipment to the communication terminal 4 for a message destination. The message transfer system 3 is constructed of functional components including a transmission request receiver (transmission request receiving means) 301, a sender authentication part 302, a communication restriction detector 303, a transmission period evaluator 304, a restricted data detector (restricted data detecting means) 305, a message converter (message converting means) 306, a destination determiner (destination determining means) 307, a message output part (message outputting means) 308, an authentication information storage 309, a subscriber information storage (subscriber information storing means) 310, a transmitting data storage 311, a message transmitter 312, a result notice data generator 321, and a result notice data transmitter 322. The components of the message transfer system 3 will be described below in detail.

The transmission request receiver 301 is a part that receives transmission request information containing a service provider ID (sender specifying information) specifying a message sender, a service ID (service specifying information) specifying a service to which a user at a message destination subscribes, a membership number (destination information) specifying the message destination, and message data to be transmitted to the message destination, from the Web server 2b or from the communication terminal 2a. For example, the transmission request receiver 301 receives message data comprised of a user ID “12345+6789” which is a combination of a service provider ID with a service ID, a password “XXXX,” a membership number “MEM001,” a title “Site Renewal,” and a body “Website was redesigned.” from the Web server 2b. The transmission request receiver 301 extracts the service provider ID, service ID, password, membership number, and message from the received transmission request information and delivers them to the sender authentication part 302, the restricted data detector 305, the message converter 306, and destination determiner 307.

The sender authentication part 302 is a part that performs a process of authenticating a message sender on the basis of the service provider ID, service ID, and password received from the transmission request receiver 301. More specifically, the sender authentication part 302 refers to the authentication information storage 309 on the basis of the service provider ID and service ID to determine whether the service provider ID and service ID are preliminarily stored in the authentication information storage 309, thereby implementing authentication of the message sender.

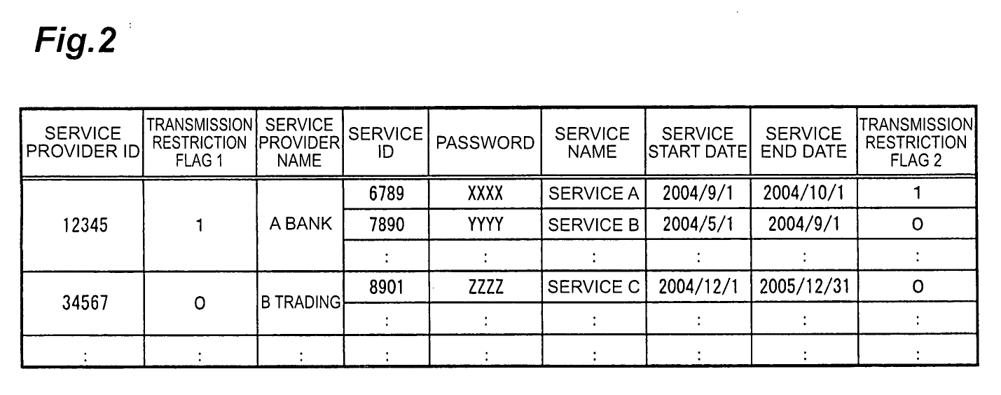

FIG. 2 shows a configuration of data stored in the authentication information storage 309. As shown in the same drawing, the authentication information storage 309 stores a service provider ID “12345” specifying a service provider of a service provided by Web server 2b, more than one service ID “6789” . . . specifying services provided by Web server 2b, and passwords “XXXX” . . . set for the respective service IDs in association with each other.

The sender authentication part 302 determines whether a record with the service provider ID and service ID agreeing with those in the request is stored in the authentication information storage 309 and, when the record is stored, the sender authentication part 302 further retrieves the password included in the record and performs authentication based on whether the retrieved password agrees with the password received from the transmission request receiver 301. For example, when the sender authentication part 302 receives the service provider ID “12345,” service ID “6789,” and password “XXXX” from the transmission request receiver 301, it retrieves the password “XXXX” from the authentication information storage 309 and performs the password authentication. The sender authentication part 302 delivers the result “OK/NG” of the above password authentication, and the record retrieved from the authentication information storage 309, to the communication restriction detector 303.

Referring back to FIG. 1, the communication restriction detector 303 is a part that, in the case of the password authentication result from the sender authentication part 302 being “OK,” detects a restriction against message transmission from a message sender and performs a process of suspending the message transmission. Specifically, the communication restriction detector 303 extracts a transmission restriction flag 1 corresponding to the service provider ID and a transmission restriction flag 2 corresponding to the service ID (cf. FIG. 2) from the record received from the sender authentication part 302, and performs the process of suspending the message transmission when either one of the flags is on, “1.” These transmission restriction flags are flags preliminarily set in the message transfer system 3 in order to restrict the message transmission in service provider units and in service units. When the transmission restriction flags both are off, “0,” the communication restriction detector 303 delivers the record received from the sender authentication part 302, to the transmission period evaluator 304.

The transmission period evaluator 304 is a part that determines whether the message is transmitted by the message transmitter within a preset transmission period and that performs a process of suspending the message transmission when the message is transmitted out of the transmission period. Specifically, the transmission period evaluator 304 extracts a service start date and a service end date (cf. FIG. 2) corresponding to the service provider ID and service ID from the record received from the communication restriction detector 303, and performs the process of suspending the message transmission when the time of reception of the transmission request information is out of the transmission period specified by the service start date and the service end date. For example, where the reception time of the transmission request information is “Aug. 31, 2004 10:00:00” and where the service start date and the service end date are “Sep. 1, 2004” and “2004/10/1,” respectively, the transmission period evaluator 304 determines that the reception time is out of the transmission period and performs the suspending process of message transmission. When the reception time is determined to be within the transmission period, the transmission period evaluator 304 delivers the record received from the communication restriction detector 303, to the message converter 306.

The restricted data detector 305 is a part that detects predetermined restricted object data from the message data included in the transmission request information when the transmission period evaluator 304 determines that the reception time of the transmission request information is within the transmission period. The restricted object data preliminarily designated is, for example, tag information containing a specific character, such as tag information containing link information to a specific Web page including character “HREF,” and tag information for embedding a graphic image containing character “IMG.” When detecting restricted object data in the message data, the restricted data detector 305 performs a control not to output the transmitting message data (which will be detailed hereinafter) to the message output part 308.

The message converter 306 is a part that converts the message data in the transmission request information into transmitting message data in a predetermined format. Namely, the message converter 306 separates the title and the body included in the message data, and edits the data by adding tag information in HTML format. The message converter 306 extracts a service name (cf. FIG. 2) corresponding to the service ID from the record received from the transmission period evaluator 304, and adds it to the message data edited as described above. Furthermore, the message converter 306 also performs a process of adding fixed tag information preliminarily registered in the message transfer system 3, to the message data. Link information to a Web page, providing information useful to users, is preferably used as the foregoing tag information. The message converter 306 delivers the transmitting message data resulting from the above-described conversion, to the message output part 308.

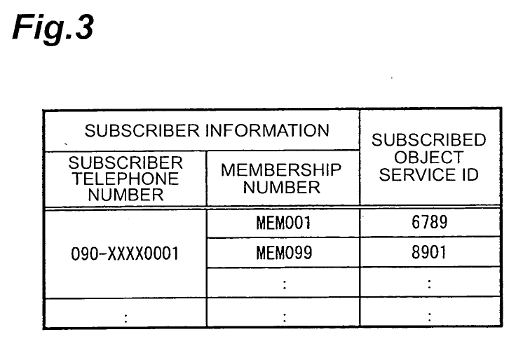

The destination determiner 307 is a part that refers to the subscriber information storage 310 to retrieve communication address information corresponding to the membership number included in the transmission request information. FIG. 3 shows a configuration of data stored in the subscriber information storage 310. As shown in the same drawing, the subscriber information storage 310 stores a subscripted object service ID (service specifying information) “6789” specifying a service provided by a message sender, a membership number (subscriber information) “MEM001” specifying a service subscriber to the service, and a subscriber telephone number “090-XXXX0001” being a telephone number of a communication terminal used by the service subscriber, in association with each other. Then the destination determiner 307 searches the subscriber information storage 310 on the basis of the service ID and the membership number included in the transmission request information, and determines whether the storage stores a record with the service ID and membership number agreeing with those in the request information. Furthermore, when the storage stores the record with the service ID and membership number agreeing with those in the request information, the destination determiner 307 retrieves the subscriber telephone number included in the record, as communication address information and delivers it to the message output part 308.

In the example of FIG. 3, where the transmission request information contains the service ID “6789” and the membership number “MEM001,” the destination determiner 307 retrieves the subscriber telephone number “090-XXXX0001” from the subscriber information storage 310 and delivers it to the message output part 308.

Referring back to FIG. 1, the message output part 308 is a part that adds the subscriber telephone number received from the destination determiner 307, as the communication address information to the transmitting message data received from the message converter 306 and outputs the resultant. In this case, the message output part 308 performs the output of the transmitting message data by storing the data into the transmitting data storage 311.

The message transmitter 312 is a part that transmits the transmitting message data stored in the transmitting data storage 311, to the communication terminal 4. Namely, the message transmitter 312 transmits the transmitting message data, using the subscriber telephone number included in the transmitting message data as a destination. In this case, the message transmitter 312 may act to actively transmit the transmitting message data to the communication terminal 4 by use of SMTP (Simple Mail Transfer Protocol) or the like, or may act to passively transmit the transmitting message data in accordance with a transmission request from the communication terminal 4.

Furthermore, the message transmitter 312 detects a transmission result at the time of a transmission of the transmitting message data, and associates the transmission result with the transmitting message data, and stores the resultant into the transmitting data storage 311. The message transmitter 312 detects a state, which shows the transmission result, such as “00 (normal end)”, “01 (“no appropriate membership number)”, and “09(communication restricted).

After the transmission of transmitting message data by the message transmitter 312, the result notice data generator 321 refers to the transmitting data storage 311 to generate message transmission result data which is provided for the Web server 2b or for the communication terminal 2a. The membership number which is a transmitted object of the message data, and the transmission result, such as “MEM111, 00,” are included in the message transmission result data. More than one membership number and corresponding transmission result may be included in the message transmission result data in case that more than one membership number is an object to be transmitted. The result notice data generator 321 outputs the generated message transmission result data to the result notice data transmitter 322.

The result notice data transmitter 322 transmits the message transmission result data to the Web server 2b or to the communication terminal 2a through the communication network 5a. In this case, the result notice data transmitter 322 may act to actively transmit the message transmission result data to the Web server 2b or to the communication terminal 2a by e-mail using SMTP or the like, or may act to passively transmit the message transmission result data by using HTTP or the like in response to a transmission request from the Web server 2b or from the communication terminal 2a.

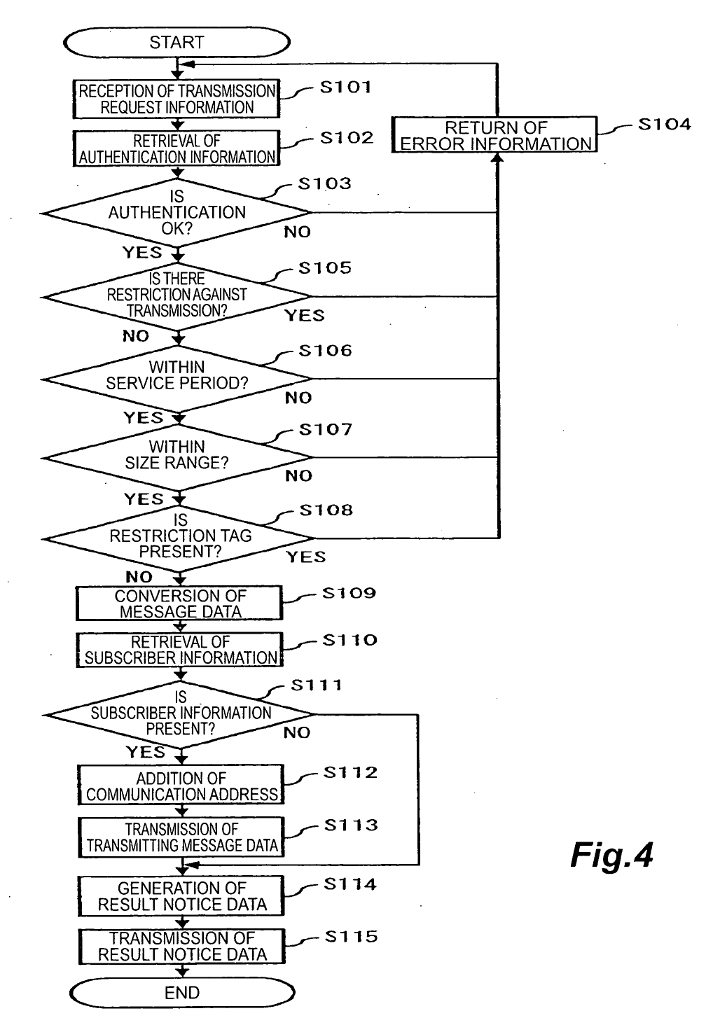

Subsequently, the operation of the message transfer system 3 according to the present embodiment will be described, together with a message transfer method according to an embodiment of the present invention. FIG. 4 is a flowchart showing the operation during message transfer by the message transfer system 3.

First, the transmission request receiver 301 of the message transfer system 3 receives the transmission request information with the message destination of communication terminal 4 from the Web server 2b or from the communication terminal 2a (step S101). Next, the sender authentication part 302 retrieves a record with the service provider ID and service ID agreeing with those in the transmission request information, from the authentication information storage 309 (step S102). Then the sender authentication part 302 determines whether the password stored in the retrieved record agrees with that in the transmission request information (step S103). When it results in determining that the passwords do not agree (step S103; NO), the sender authentication part 302 sends error information back to the Web server 2b or to the communication terminal 2a being the sender of the transmission request information (step S104), and thereafter returns the processing to step S101.

On the other hand, when it is determined that the passwords agree (step S103; YES), the communication restriction detector 303 refers to the record retrieved from the authentication information storage 309, thereby determining whether the message transmission by the message sender is restricted (step S105). When it is determined that either the transmission restriction flag 1 or the transmission restriction flag 2 set in the record is “1” (step S105; YES), the communication restriction detector 303 sends error information back to the sender of the transmission request information (step S104), and thereafter returns the processing to step S101.

On the other hand, when the transmission restriction flag 1 and the transmission restriction flag 2 are determined both to be “0” (step S105; NO), the transmission period evaluator 304 refers to the record retrieved from the authentication information storage 309, thereby determining whether the reception time of the transmission request information is within the transmission period (step S106). When it is determined as a result that the reception time of the transmission request information is out of the transmission period (step S106; NO), the transmission period evaluator 304 sends error information back to the sender of the transmission request information (step S104), and then returns the processing to step S101.

On the other hand, when it is determined that the reception time of the transmission request information is within the transmission period (step S106; YES), the restricted data detector 305 determines whether the message data in the transmission request information is not more than a predetermined data size (e.g., 500 bytes) (step S107). When the determination result is that the message data is over the predetermined data size (step S107; NO), the restricted data detector 305 sends error information back to the sender of the transmission request information (step S104), and then returns the processing to the step S101.

On the other hand, when it is determined that the message data is not more than the predetermined data size (step S107; YES), the restricted data detector 305 further determines whether the message data includes tag information as restricted object data (step S108). When the result is that the message data includes restricted object data (step S108; YES), the restricted data detector 305 sends error information back to the sender of the transmission request information (step S104), and thereafter returns the processing to step S101, thereby performing the control to prevent the message output part 308 from outputting the transmitting message data.

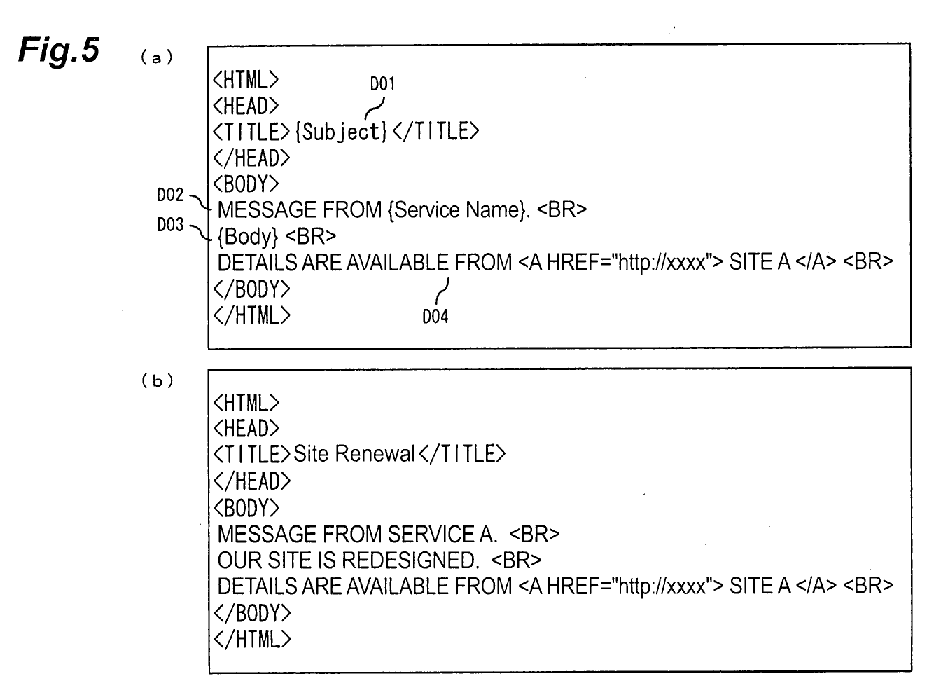

On the other hand, when the message data includes no restricted object data (step S108; NO), the message converter 306 converts the message data into transmitting message data (step S109). In FIG. 5, (a) is a diagram showing a content of a template for the conversion process by the message converter 306, and (b) a diagram showing a content of transmitting message data resulting from the conversion by the message converter 306. The message converter 306 preliminarily retains the template for the conversion process as shown in FIG. 5 (a). This template is described including tag information in HTML format and has an index D01 “{Subject}” for replacement to a title in the message data, an index D02 “{Service Name}” for replacement to a service name corresponding to the service ID in the transmission request information, an index D03 “{Body}” for replacement to a body in the message data, and fixed link information D04 “<A HREF=“http://xxxx”>.” The message converter 306 applies the title and body in the message data, and the service name retrieved from the authentication information storage 309, to the portions of these index D01, index D03, and index D02, thereby converting the template into the transmitting message data as shown in FIG. 5 (b).

Referring back to FIG. 4, the destination determiner 307 refers to the subscriber information storage 310 to retrieve the record with the service ID and membership number agreeing with those in the transmission request information (step S110). Then the destination determiner 307 determines whether there is a record with the service ID and membership number agreeing with those in the request information, as a result of the retrieval process (step S111). When it is determined that there is no coincident record (step S111; NO), the message transfer process is terminated. On the other hand, when it is determined that there is a coincident record (step S111; YES), the destination determiner 307 retrieves the subscriber telephone number included in the pertinent record, and thereafter the message output part 308 adds the subscriber telephone number to the transmitting message data and stores it into the transmitting data storage 311 (step S112).

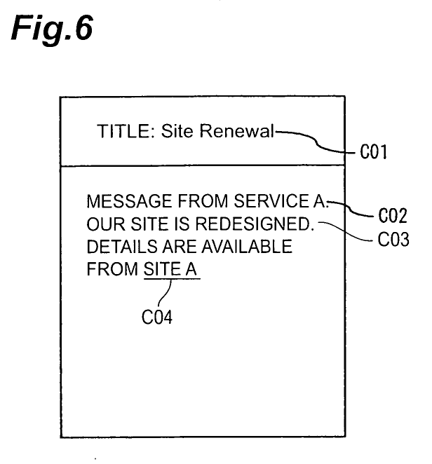

After that, the message transmitter 312 retrieves the transmitting message data from the transmitting data storage 311 and transmits it to the communication terminal 4 (step S113). FIG. 6 shows an example of outputting the transmitting message data at communication terminal 4. As shown in the same drawing, the indices D01, D02, and D03 after the replacement by the message converter 306 are outputted as character strings C01, C02, and C03, and the link information D04 fixedly added by the message converter 306 is outputted as a character string C04 with a link function.

After the transmitting message data being transmitted, the result notice data generator 321 generates the message transmission result data in which the membership number that is a transmitted object of the transmitting message data and the transmission result are included (step S114). After that, the result notice data transmitter 322 transmits the generated message transmission result data to the Web server 2b or to the communication terminal 2a, being the sender of the transmission request information, by e-mail (step S115).

In the message transfer system 3 described above, when the transmission request information is received from the message sender, the message data in the transmission request information is converted into data in the format preliminarily defined by the template, the communication address information corresponding to the membership number is added to the data, and the data is outputted as transmitting message data to the communication terminal 4. When restricted object data such as tag information is detected in the message data, the control is performed so as not to transmit the restricted object data to the communication terminal 4. Thus, only the message data in the specific format is permitted to be transmitted on the message transfer and, transmission of useless messages is prevented by, for example, restricting transmission of data of kinds that are likely to be abused.

The subscriber information about users subscribing to each service provided by the message sender is preliminarily registered in the subscriber information storage 310, and a service ID to identify a service provided by the message sender is received from the message sender upon a message transmission request. When the message destination identified by the membership number corresponds to a subscriber to the service specified by the service ID, the message data is outputted, whereby the message transmission is permitted for only subscribers to the service provided by the message sender.

Preferably, the transmission request receiving means further receives service specifying information specifying a service to which the message destination subscribes, from the message sender equipment; the message transfer system further comprises: subscriber information storing means for storing service specifying information specifying a service provided by the message sender, and subscriber information specifying every service subscriber to the service, in association with each other; and destination determining means for referring to the subscriber information storing means on the basis of the destination information and the service specifying information, thereby determining whether the subscriber information corresponding to the destination information is registered; when the destination determining means determines that the subscriber information is registered, the message outputting means adds the communication address information to the transmitting message data and outputs the resultant.

In this configuration, the subscriber information about a user subscribing to a service provided by the message sender is preliminarily registered, and the service specifying information to discriminate the service provided by the message sender is received from the message sender upon the message transmission request. When the message destination corresponds to a subscriber to the service specified by the service specifying information, the message data is outputted; therefore, the message transmission can be permitted for only subscribers to the service provided by the message sender.

Furthermore, preferably, when the restricted data detecting means detects tag information in the message data, the restricted data detecting means controls the message converting means so as to filter out the tag information from the message data. With provision of this restricted data detecting means, it is feasible to securely prevent transmission of the tag information that is likely to be transmitted as useless data.

Furthermore, preferably, when the restricted data detecting means detects tag information in the message data, the restricted data detecting means performs a control not to output the transmitting message data. In this case, it is also feasible to securely prevent transmission of the tag information that is likely to be transmitted as useless data.

Furthermore, preferably, the message converting means further adds preregistered tag information to the transmitting message data, and the message outputting means outputs the transmitting message data to which the tag information and the communication address information is added. In this configuration, for example, even in a case where there is a limitation to transmission of tag information such as link information from the message sender side, information more useful to a recipient can be transmitted by preliminarily fixedly setting and adding the tag information.

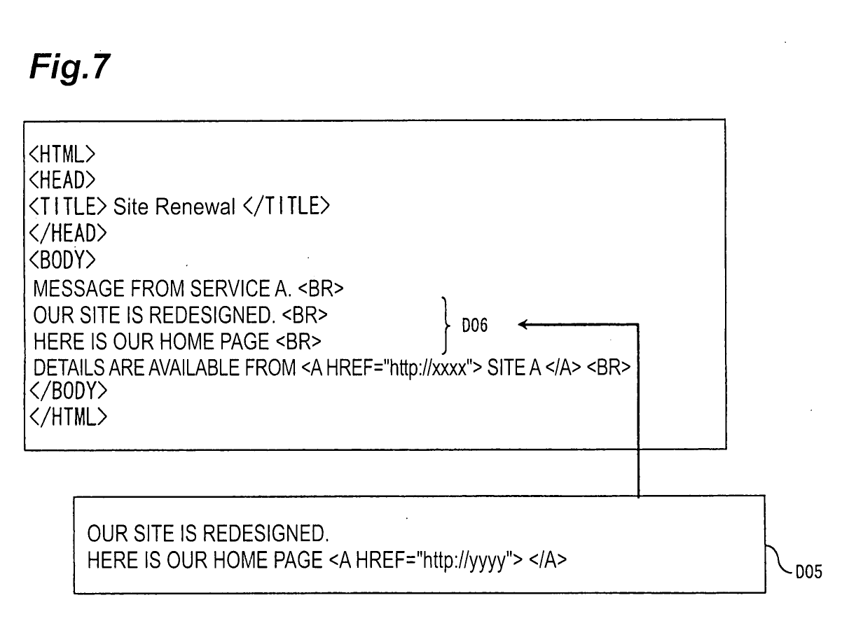

The present invention is by no means limited to the above embodiment. For example, the restricted data detector 305 of the message transfer system 3 is configured to perform the control so as not to transmit the transmitting message data with detection of restricted object data, but the system may also be configured to perform such a control that, with detection of restricted object data such as tag information, the message converter 306 filters out the message data by deleting the restricted object data. In this case, for example, the message converter 306 deletes the tag information including a specific character such as character “HREF” from the body included in the message data, and thereafter applies the body to the template, thereby implementing the conversion into transmitting message data. FIG. 7 shows a modification example of transmitting message data resulting from the conversion by the message converter 306. As shown in the same drawing, the message converter 306 deletes the link information “<A HREF=“http://yyyy”>” corresponding to restricted object data from the data D05 of the body included in the message data received from the message sender, to convert the data D05 into data D06, thereby generating transmitting message data.

The message transfer system 3 is configured to convert the message data into data in HTML format and to transfer it, but the data format is not limited to specific formats; the system may also be configured to act so as to convert the data into another data format such as the text data format.

The message transfer system 3 is configured to transmit the transmitting message data to the communication terminal 4 after storing it into the transmitting data storage 311, but the system may also be arranged to act so as to transfer the data via another computer system such as a mail server to the communication terminal.

The restricted object data preliminarily set in the message transfer system 3 is not limited to the tag information, but various data such as scripts described in a program language can also be set as restricted object data.

### INDUSTRIAL APPLICABILITY

The present invention is intended for a message transfer system and message transfer method transmitting a message on a communication network, and prevents transmission of a useless message by restricting a content of transmitted message on the communication network.

1-6. (canceled)

7. A message transfer system comprising:
transmission request receiving unit for receiving transmission request information containing destination information specifying a message destination, and message data to be transmitted to the message destination, from a message sender equipment;
a message converting unit for converting the message data into transmitting message data in a predetermined format;
a message outputting unit for adding communication address information corresponding to the destination information, to the transmitting message data resulting from the conversion by the message converting unit, and outputting the resultant; and
a restricted data detecting unit for, when detecting predetermined restricted object data in the message data in the transmission request information received by the transmission request receiving unit, performing a control not to transmit the restricted object data.

8. The message transfer system according to claim 7, wherein the transmission request receiving unit further receives service specifying information specifying a service to which the message destination subscribes, from the message sender equipment,
the message transfer system further comprising:
a subscriber information storing unit for storing service specifying information specifying a service provided by the message sender, and subscriber information specifying every service subscriber who subscribes to said service, in association with each other; and
a destination determining unit for referring to the subscriber information storing unit on the basis of the destination information and the service specifying information, thereby determining whether the subscriber information corresponding to the destination information is registered,
wherein when the destination determining unit determines that the subscriber information is registered, the message outputting unit adds the communication address information to the transmitting message data and outputs the resultant.

9. The message transfer system according to claim 7, wherein when the restricted data detecting unit detects tag information in the message data, the restricted data detecting unit controls the message converting unit so as to filter out the tag information from the message data.

10. The message transfer system according to claim 7, wherein when the restricted data detecting unit detects tag information in the message data, the restricted data detecting unit performs a control not to output the transmitting message data.

11. The message transfer system according to claim 7, wherein the message converting unit further adds preregistered tag information to the transmitting message data, and
wherein the message outputting unit outputs the transmitting message data to which the tag information and the communication address information is added.

12. A message transfer method comprising:
a transmission request receiving in which a transmission request receiving unit receives transmission request information containing destination information specifying a message destination, and message data to be transmitted to the message destination, from a message sender equipment;
a message converting in which a message converting unit converts the message data into transmitting message data in a predetermined format;
a message outputting in which a message outputting unit adds communication address information corresponding to the destination information, to the transmitting message data resulting from the conversion in the message converting unit, and outputs the resultant; and
a restricted data detecting in which a restricted data detecting unit, when detecting predetermined restricted object data in the message data in the transmission request information received in the transmission request receiving, performs a control not to transmit the restricted object data.
